(19) United States
(12) Patent Application Publication
(10) Pub. No.: US 2010/0050846 A1
(43) Pub. Date: Mar. 4, 2010

(54) Band-sawing machine

(76) Inventor: James Liu, Taichung Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/203,182

(22) Filed: Sep. 3, 2008

(51) Int. Cl. B26D 1/46

(52) U.S. Cl. 83/811

(57) ABSTRACT

A band-sawing machine comprises a machine base having a transverse through-hole and a plurality of support rod holes; a tension adjustment means including a fastening rod, first and second blocks, two support rods, and an adjusting seat, with the first and second blocks and adjusting seat are slidable along the support rods; a blade mounting pulley coupled to the adjusting seat pivotally; a band sawing blade provides on the blade mounting pulley; and a rapid handling means including a handle and a cam shaft; wherein the handle is inserted through the transverse through-hole and coupled to the cam shaft which is adapted for selectively pushing the first block to move upward to drive the blade mounting pulley to move therewith and change the band sawing blade.

### BACKGROUND OF THE INVENTION

1. Field of the Invention

The present invention relates to a band-sawing machine.

2. Description of the Related Art

Referring to FIG. 9, a conventional band-sawing machine includes a machine base 1, two blade mounting pulleys 2, a band saw blade 3, a guiding means 4 and a worktable 5. One of the blade mounting pulleys 2 is connected to the machine base 1 via a vertical screw rod 6. The distance between the two blade mounting pulleys 2 can be adjusted by operating the vertical screw rod 6 for loosening or tightening the band saw blade 3 selectively. However, to detach the band saw blade 3 from the blade mounting pulleys 2 is needed to turn the vertical screw rod 6 for long time. It will waste time for changing the band saw blade 3 and adjusting the position of the band saw blade 3, which may lead to low working efficiency The present invention is therefore intended to obviate or at least alleviate the problems encountered in prior art.

### SUMMARY OF THE INVENTION

According to the present invention there is provided, a band sawing machine includes a machine base that has a transverse through-hole and numbers of support rod holes; a tension adjustment means that has a fastening rod, first and second blocks, two support rods, an adjusting seat, with the fastening rod inserted through the first block and engaged with the second block, with the support rods respectively inserted through the first and second blocks and the adjusting seat, and with two ends of the support rods inserted through the support rod holes; a blade mounting pulley pivotally coupled to the adjusting seat, with a band sawing blade provided on the blade mounting pulley; and a rapid handling means having a handle and a cam shaft, with the handle inserted through the transverse through-hole and coupled to the cam shaft, with the cam shaft selectively pushing the first block upward for driving the blade mounting pulley to move with the adjusting seat and changing the band sawing blade easily.

Other objectives, advantages, and features of the invention will become more apparent from the following detailed description when taken in conjunction with the accompanying drawings.

### BRIEF DESCRIPTION OF THE DRAWINGS

The present invention will be described via detailed illustration of the preferred embodiment referring to the drawings.

FIG. 1 is a perspective view of a band-sawing machine according to the preferred embodiment of the present invention.

FIG. 2 is an exploded view of the band-sawing machine shown in FIG. 1.

FIG. 3 is a cross-sectional view taken along 3-3 in FIG. 1.

FIG. 4 is a cross-sectional view similar to FIG. 3.

FIG. 5 is a cross-sectional view taken along 5-5 in FIG. 1.

FIG. 6 is a cross-sectional view similar to FIG. 5.

FIG. 7 is a cross-sectional view similar to FIG. 3.

FIG. 8 is a cross-sectional view similar to FIG. 7.

FIG. 9 is a perspective view of a conventional band-sawing machine.

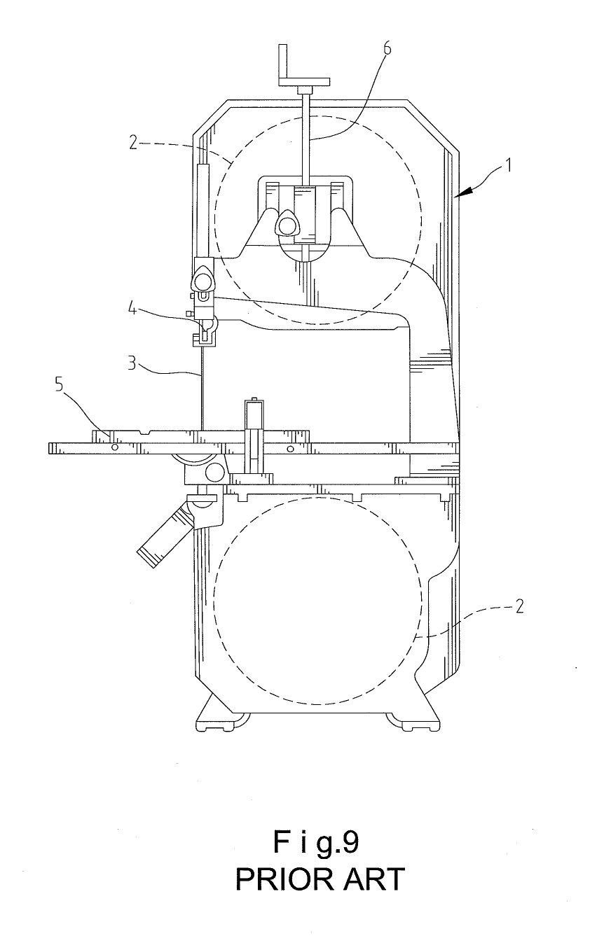

### DETAILED DESCRIPTION OF THE PREFERRED EMBODIMENT

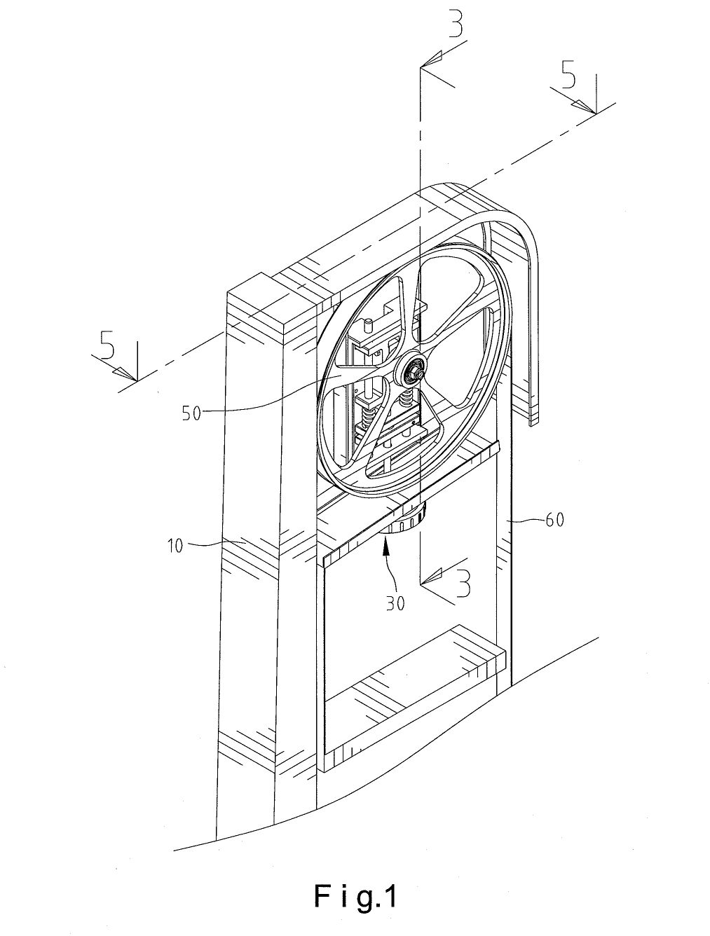

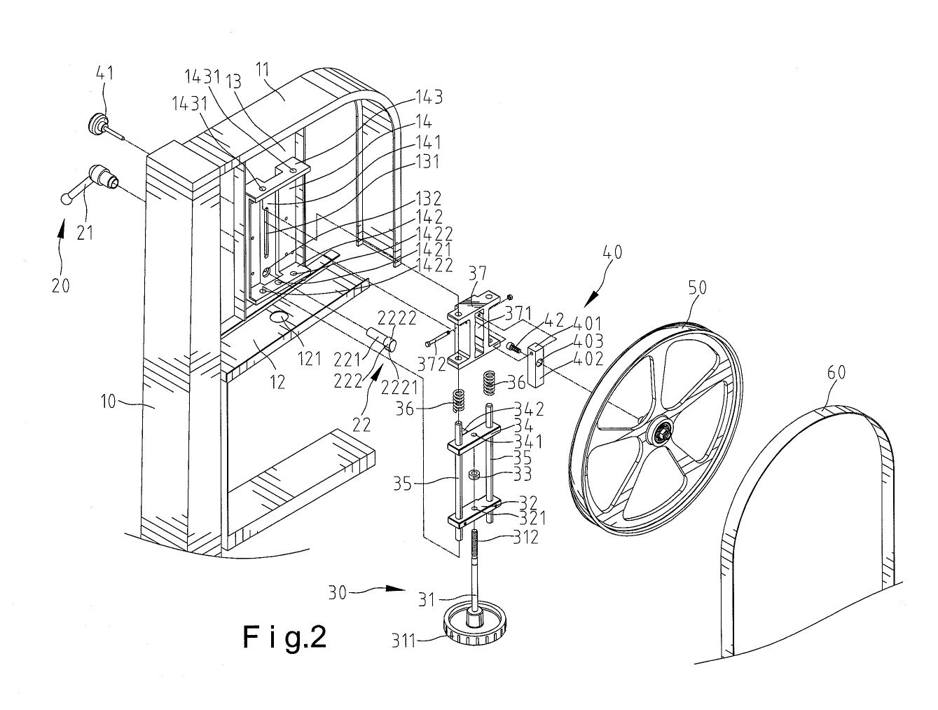

Referring to FIGS. 1 and 2, a band-sawing machine in accordance with the preferred embodiment of the present invention includes a machine base 10, a rapid handling means 20, a tension adjustment means 30, a tilt adjustment means 40, a blade mounting pulley 50 and a band sawing blade 60.

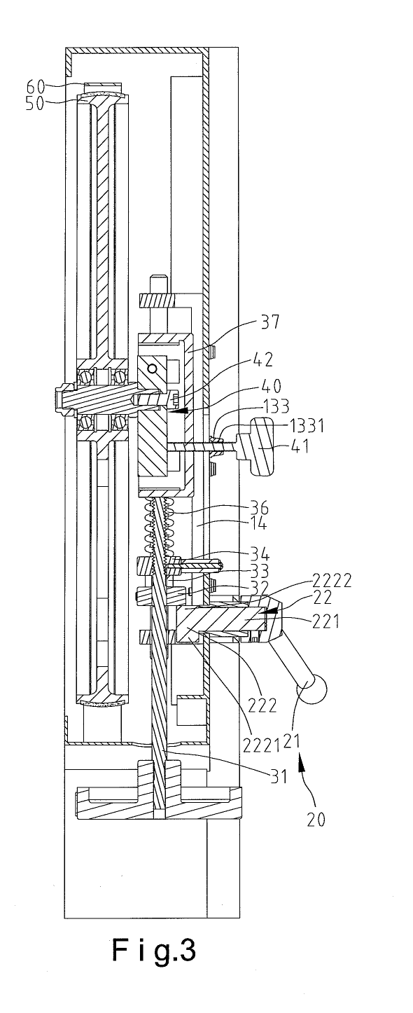

The machine base 10 includes first and second mounting frames 11 and 12 installed thereto. The first mounting frame 11 is preferably in form of L-shaped and consists of top and lateral plates. The second mounting frame 12 is preferably in form of U-shaped and has lateral, top and bottom plates, with second mounting frame 12 attached on the machine base 10 via the lateral plate of the second mounting frame. A connecting member 13 is adapted for connecting the top plates of the first and second mounting frames 11 and 12 and includes a slot 131 longitudinally formed thereon, a through-hole 132 defined below the slot 131 axially and adjacent to the second mounting frame 12 and a fixed portion 133 protruding from a side thereof and having a threaded aperture 1331 (shown in FIG. 3), with the threaded aperture 133 in communication with the slot 131. The rapid handling means 20 is installed on the through-hole 132 pivotally.

A fixed seat 14 is fixed to another side of the connecting plate 13 opposite to the fixed portion 133. A receiving groove 141 is formed on the center of the fixed seat 14 longitudinally. First and second support portions 142 and 143 are respectively integrated with the top and bottom of the fixed seat 14 and extend opposite to the connecting plate 13, with the fist and second support portions 142 and 143 parallel to the top plate of the first mounting frame 11. A fastening rod hole 1421 and two support rod holes 1422 are formed on the first support portion 142, with the fastening rod hole 1421 between the support rod holes 1422. Two support rod holes 1431 are formed on the second support portion 143, with the support rod holes 1431 of the second support portion 142 corresponding to the support rod holes 1422 of the first support portion 142, respectively.

The rapid handling means 20 includes a handle 21 and a cam shaft 22, with the handle 21 and the cam shaft 22 provided on two sides of the connecting plates 13 respectively. Shaft and cam ends 221 and 222 are defined on two ends of the cam shaft 22, with the cam end 222 being eccentric with respect the shaft end 221. A longitudinal axis is defined through the center of the shaft end 221 to the cam end 222 as to define a larger portion 2221 and smaller portion 2222, with a distance between the larger portion 2221 and the longitudinal axis being larger than a distance between the smaller portion 2222 and the longitudinal axis. The shaft end 221 is inserted through the through-hole 132 of the connecting plate 13 and coupled to the handle 21. The cam shaft 22 is able to be driven by the handle 21, with the cam end 222 eccentrically rotated with the shaft end 221.

The tension adjustment means 30 includes a fastening rod 31, first and second blocks 32 and 34, a spaced element 33, two support rods 35, two elastic elements 36 and an adjusting seat 37. The first and second blocks 32 and 34 and adjusting seat 37 are disposed between the first and second support portions 142 and 143 in sequence and parallel to one another. The larger and smaller portions 2221 and 2222 of the cam end 222 are abutted against the first block 32 alternatively by turning the cam shaft 22.

The spaced element 33 is provided between the first and second blocks 32 and 34. The first and second blocks 32 and 34 keep being spaced from each other via the spaced element 33. The support rods 35 are respectively inserted through the support rod holes 1422 of the first support portion 142, two ends of the first and second blocks 32 and 34, the adjusting seat 37 and the support rod holes 1431 of the second support portion 143. The first and second blocks 32 and 34 are slidable along the support rods 35 so that the distance between the first and second blocks 32 and 34 is adjustable. The elastic elements 36 are mounted on the support rods 35 respectively and provided between the second block 34 and adjusting seat 37.

The fastening rod 31 has an urging disk 311 and a threaded portion 312 on two ends thereof respectively. The fastening rod 31 is inserted through the through-hole 121 of the second mounting frame 12 and the fastening rod hole 1421 of the first support portion 142, a hole 321 of the first block 32, the spaced element 33 and a hole 341 of the second block 32. The holes 321 and 341 of the first and second blocks 32 and 34 are defined between the support rods 35. The distal end of the threaded portion 312 of the fastening rod 31 is selectively abutted against the bottom of the adjusting seat 37. The urging disk 311 is provided outside of the through-hole 121 of the second mounting frame 12 opposite to the threaded portion 312 and coupled to the fastening rod 31. The cam end 222 of the cam shaft 22 is provided below the first block 32 as to selectively push the first block 32 upward for adjusting the height of the first block 32 with respect the first support portion 142. A protrusion 342 protrudes from a side of the second block 34 toward the connecting plate 13 and is inserted to the slot 131 of the connecting plate 13 so that the second block 34 is limited to slide along the slot 131. The adjusting seat 37 has a receiving slot 371 formed longitudinally.

The tilt adjustment means 40 is coupled in the receiving slot 371 and includes first and second ends 401 and 402 and a through-hole 403 defined thereon and adjacent to the second end 402. The first end 401 of the tilt adjustment means 40 is pivotally connected to the adjusting seat 37 via a bolt 372. A direction of engagement of the first end 401 of the tilt adjustment means 40 with the adjusting seat 37 is perpendicular to a direction of engagement of the fixed element 42 and the blade mounting pulley 50. An urging knob 41 is engaged with the threaded aperture 1331 of the fixed portion 133 and inserted to the slot 131 as to selectively push the second end 402 of the tilt adjustment means 40. A fixed element 42 is inserted through the through-hole 403 for coupling the blade mounting pulley 50 to the tilt adjustment means 40. The band sawing blade 60 is provided on the blade mounting pulley 50. The first mounting frame 11 is adapted for surrounding the periphery of the blade mounting pulley 50 which is provided between the top plates of the first and second mounting frames 11 and 12.

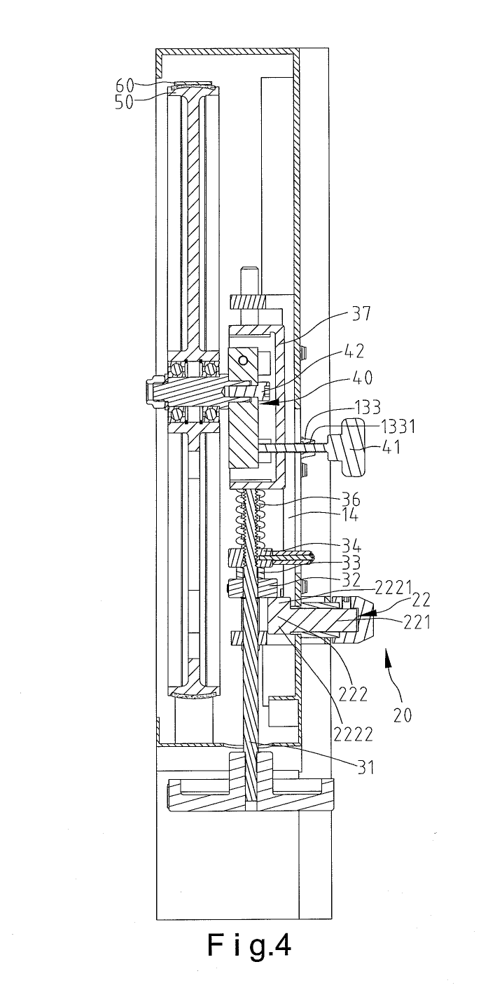

FIGS. 3 and 4 shows detaching the band sawing blade 60 from the blade mounting pulley 50 rapidly via actuating the rapid handling means 20. While the band sawing blade 60 is attached with the blade mounting pulley 50 tightly, shown in FIG. 4, the larger portion 2222 is driven to abut against the first block 32 as to push the first block 32, the spaced element 33, the second block 34 and the adjusting seat 37 upward and then the tilt adjustment means 40 is driven to move upward for driving the blade mounting pulley 50 to move toward the band sawing blade 60 for tightly attaching with the band sawing blade 60. While it's desired to loose the band sawing blade 60 from the blade mounting pulley 50, turning the cam shaft 22 to let the larger portion 2221 of the cam end 222 detach from the first block 32. Therefore, the first block 32 moves downward to abut against the smaller portion 2222 of the cam end 222 (shown in FIG. 3). And then, the spaced element 33, the second block 34 and the adjusting seat 37 move downward with the first block 32 so that the tilt adjustment means 40 is driven to move downward for driving the blade mounting pulley 50 to move away from the band sawing blade 60 for easy detachment of the band sawing blade 60 from the blade mounting pulley 50.

After changing the band sawing blade 60 from the blade mounting pulley 50, the rapid handling means 20 is able to turn for letting the larger portion 2221 of the cam end 222 abut against the first block 32 as to tightly attach the new band sawing blade 60 to the blade mounting pulley 50 again.

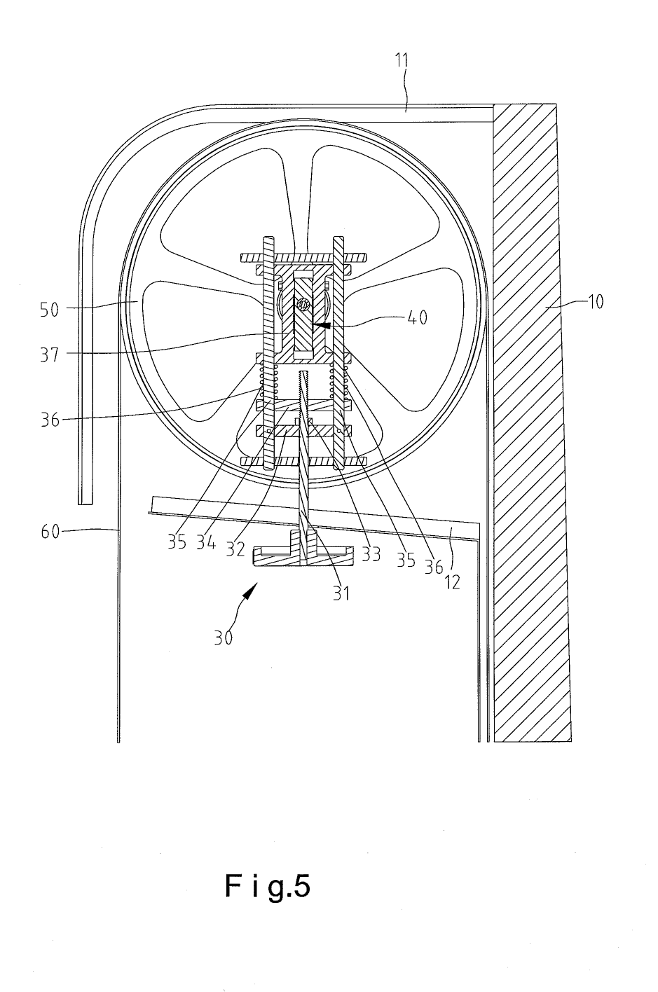

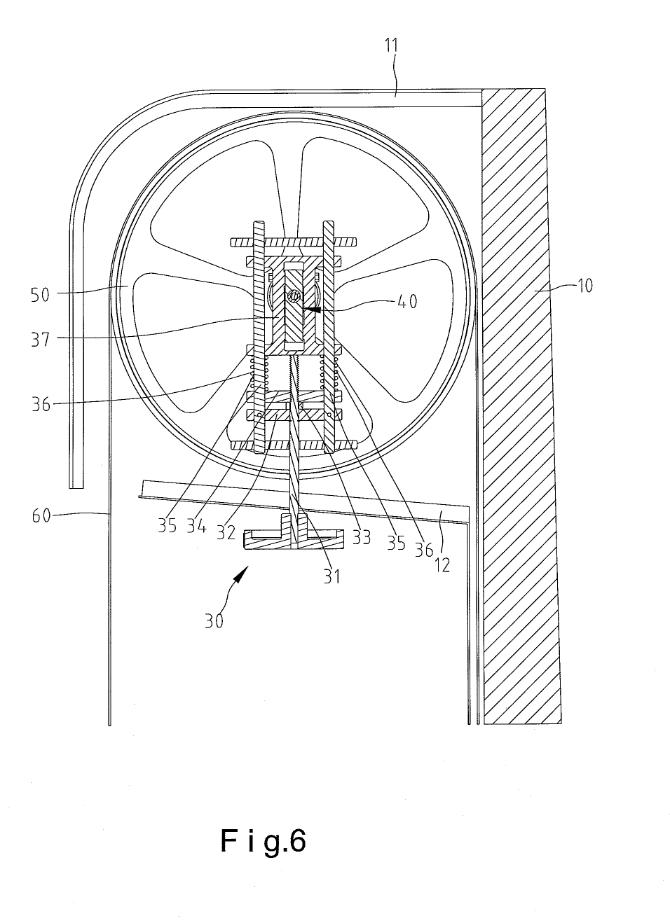

Referring to FIGS. 5 and 6 show adjusting the tension of the band sawing blade 60 on the blade mounting pulley 50 via actuating the tension adjustment means 30. While it's desired to adjust the band sawing blade 60 to tightly attach with the blade mounting pulley 50, actuating the urging disk 311 to turn the fastening rod 31 to drive the second block 34 to move upward. And then the second block 34 pushes the elastic elements 36 to move the adjusting seat 37 upward as to drive the tilt adjustment means 40 with the blade mounting pulley 50 to move upward together. Therefore, the blade mounting pulley 50 is driven to attach with the band sawing blade 60 tightly.

While it's desired to adjust the band sawing blade 60 to slightly detach from the blade mounting pulley 50, actuating the urging disk 311 to turn the fastening rod 31 to drive the second block 34 to move downward and away from the adjusting seat 37. Therefore, the tilt adjustment means 40 and the blade mounting pulley 50 are driven to move downward together for slightly detaching the band sawing blade 60 from the blade mounting pulley 50.

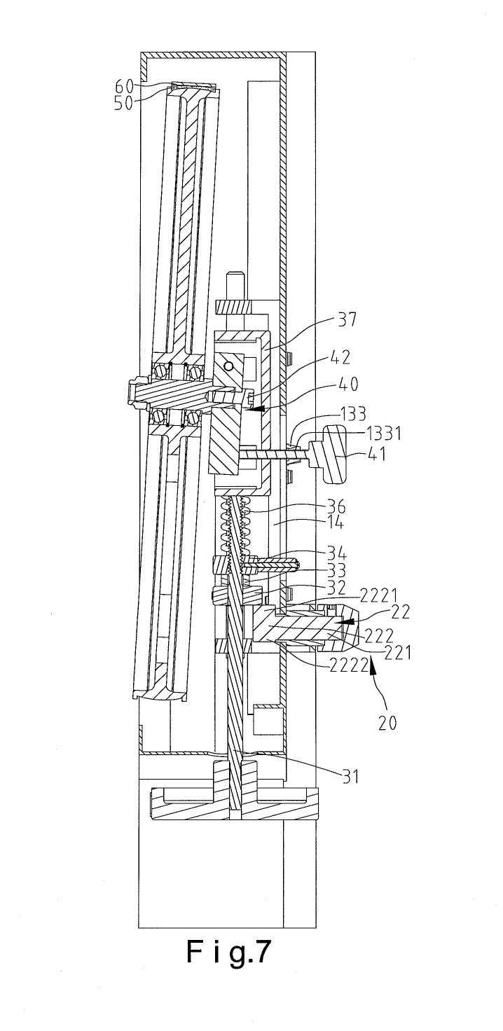

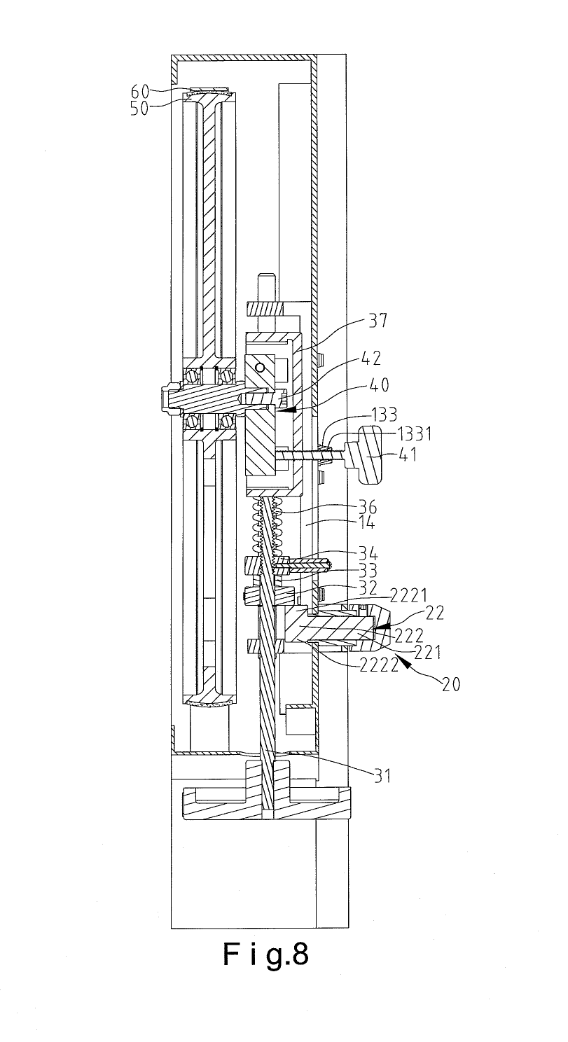

Referring to FIGS. 7 and 8 show adjusting a tilt angle of the blade mounting pulley 50 with respect to the connecting plate 13 via actuating the tilt adjustment means 40. While it's desired to adjust the position of the blade mounting pulley 50 with respect to the connecting plate 13 and the tilt angle of the blade mounting pulley 50 with respect to the connecting plate 13 to be a desired tilt angle, actuating the urging knob 41 to push the second end 402 of the tilt adjustment means 40 so that the blade mounting pulley 50 that is installed to the first end 401 pivots with respect to the adjusting seat 37 for adjusting the tilt angle of the blade mounting pulley 50 with respect to the connecting plate 13. And the tilt angle of the band sawing blade 60 can also be adjusted with the blade mounting pulley 50. Moreover, because the blade mounting pulley 50 is installed to the first end 401 of the tilt adjustment means 40 and the urging knob 41 is adapted for pushing the second end 402 of the tilt adjustment means 40. When the urging knob 41 is actuated, the first end 401 will be driven by urging knob 41 indirectly and slightly pivot with respect the adjusting seat 37. So that the tilt angle of the blade mounting pulley 50 with the band sawing blade 60 can be adjusted finely.

While the specific embodiments have been illustrated and described, numerous modifications come to mind without significantly departing from the spirit of invention and the scope of invention is only limited by the scope of accompanying claims.

What is claimed is:

1. A band-sawing machine comprising:
a machine base having a transverse through-hole;
a tension adjustment means including a fastening rod, first and second blocks, two support rods, and an adjusting seat;
wherein the fastening rod is inserted through the first block and engaged with the second block; wherein the support rods are inserted through the first and second blocks and the adjusting seat and installed the tension adjustment means to the machine base, with the first and second blocks and adjusting seat are slidable along the support rods;
a blade mounting pulley coupled to the adjusting seat pivotally;
a band sawing blade provides on the blade mounting pulley; and
a rapid handling means including a handle and a cam shaft;
wherein the handle is inserted through the transverse through-hole and coupled to the cam shaft which is adapted for selectively pushing the first block to move upward to drive the blade mounting pulley to move therewith and change the band sawing blade.

2. The band-sawing machine as claimed in claim 1, further comprising a tilt adjustment means connected to the adjusting seat pivotally and having first and second ends, with the blade mounting pulley attached with the tilt adjustment means, with the first end connected to the adjusting seat pivotally.

3. The band-sawing machine as claimed in claim 1, wherein the cam shaft further includes a shaft end and a cam end, with the cam end provided below the first block and having a larger portion and a smaller portion; wherein the cam shaft defines a longitudinally axis along the center of the shaft end to the cam end, with a distance between the larger portion and the longitudinally axis being larger than a distance between the smaller portion and the longitudinally axis.

4. The band-sawing machine as claimed in claim 2, further comprising a fixed portion adjacent to the transverse through-hole and extending opposite to the blade mounting pulley and a urging knob provided to insert through the fixed portion for selectively pushing the second end of the tilt adjustment means.

5. The band-sawing machine as claimed in claim 4, wherein the tilt adjustment means further comprises a fixed element and a through-hole formed adjacent to the first end of the tilt adjustment means, with the fixed element inserted through the through-hole of the tilt adjustment means and engaged with the blade mounting pulley.

6. The band-sawing machine as claimed in claim 5, wherein a direction of engagement of the first end of the tilt adjustment means with the adjusting seat is perpendicular to a direction of engagement of the fixed element and the blade mounting pulley.

7. The band-sawing machine as claimed in claim 1, further comprising a spaced element provided between the first and second blocks for spacing the first and second blocks from each other.

8. The band-sawing machine as claimed in claim 1, further comprising a connecting plate, a fixed seat and a plurality of support rod holes, with the transverse through-hole provided on the connecting plate, and with the support rod holes provided on the fixed seat.

9. The band-sawing machine as claimed in claim 8, further comprising a slot formed on the connecting plate longitudinally and a protrusion extending toward the connecting plate and limited to slide along the slot.

10. The band-sawing machine as claimed in claim 8, with the support rods inserted through the support rod holes of the fixed seat for installation of the support rods to the machine base.
